(19) United States
(12) Patent Application Publication
(10) Pub. No.: US 2011/0160100 A1
(43) Pub. Date: Jun. 30, 2011

(54) COMPOSITION OF PACKER FLUID FOR DEEP AND ULTRA-DEEP WELLS IN ENVIRONMENTS CONTAINING CO2

(75) Inventors: Marcia Cristina Khali OLIVEIRA, Rio de Janeiro (BR); Alexandre Zacarias Ignàcio PEREIRA, Rio de Janeiro (BR); Ilson Palmieri BAPTISTA, Rio de Janeiro (BR); Carlos José Bandeira de Mello JOIA, Rio de Janeiro (BR)

(73) Assignee: PETROLEO BRASILEIRO S.A. - PETROBRAS, Rio de Janeiro (BR)

(21) Appl. No.: 12/980,033

(22) Filed: Dec. 28, 2010

(30) Foreign Application Priority Data
Dec. 28, 2009 (BR) PI 0905255-0

(51) Int. Cl. C09K 8/06

(52) U.S. Cl. 507/139

(57) ABSTRACT

A composition of a packer fluid which comprises biodiesel glycerin to be used in deep and ultra-deep wells in environments containing CO₂ and a process of using the same. This fluid presents a specific mass of at least 1.15 g/cm³, adequate viscosity for pumping at less than 2,000 cP and corrosive potential of up to 3 mm in 30 years. In addition to this, the composition of this packer fluid is compatible with the elastomers normally employed and does not degrade when exposed to temperatures lower than 100° C. The packer fluid is injected into an oil well as part of a well packer process.

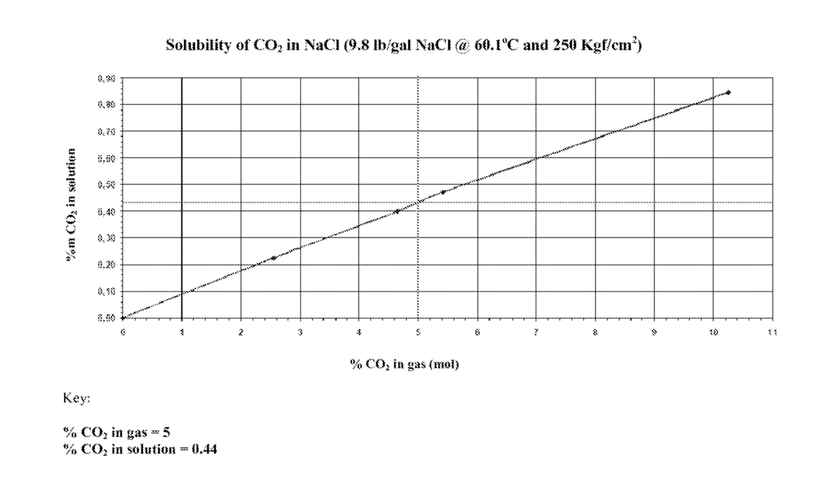

This application claims foreign priority to Brazilian Patent Application PI 0905255-0, filed Dec. 28, 2009, the contents of which are incorporated herein by reference.

### FIELD OF INVENTION

This invention is directed to the field of chemical compositions applied to packer fluids. More specifically, this invention describes a composition of a packer fluid composed of biodiesel glycerin to be used in deep and ultra-deep wells in environments containing CO₂.

### FUNDAMENTALS OF THE INVENTION

In the petroleum industry, packer refers to all the operations required to begin oil and/or gas production using a recently drilled well. Technical/operating and economic factors are observed which are capable of maximizing the flow of production without damaging the reservoir and minimizing the time and frequency of interventions, hence minimizing the cost of prospecting. In one of the operations performed during the packer stage, a fluid referred to as packer fluid is injected into the well with a view to: containment of the reservoirs using hydrostatic pressure without causing damages to the producer formation; reducing the pressure gradient between the production column and lining to avoid collapse; and protecting metals and elastomers from corrosion. The chemical composition of the fluid is fundamental to this process.

With the discovery of large recoverable amounts of petroleum of excellent quality in deposits beneath the salt layer in the Bay of Santos in Brazil, studies have shown that to make the production of petroleum and gas viable in this region, many technological production challenges which arise from the exploitation in layers of salt in ultra-deep areas must be overcome. Among these challenges is the packer of the wells. It has been identified that within this production scenario, the well lining is susceptible to collapse due to the influence of salt and that the high CO₂ content in the gas lift (commonly used lift method) compromises the performance of the packer fluids commonly used (saline solutions) throughout the productive life of the well.

The traditional packer fluid is a saline solution free of solids which must be compatible with the reservoir and the fluids contained in it and must have a specific mass capable of exercising a hydrostatic pressure higher than the static pressure of the formation, sufficient viscosity to perform the job of conveying detritus to the surface during well cutting and/or cleaning operations and also be compatible with the components of the well. The chemical composition of the fluid is fundamental to the process, as the reaction of the ions present in the fluid with the clay minerals of the rock may cause these to swell leading to damages in the formation and obstruction of the perforation.

In these fluids an inorganic salt is used such sodium chloride (NaCl) and potassium chloride (KCl) with the aim of avoiding the hydration of the formation clays. The choice of salt is made based on the specific weight of the fluid to be used. These salts make the medium aggressive causing the corrosion of metallic materials. To minimize this effect, corrosion inhibitive products are added to these fluids.

Due to the higher concentration of CO₂ in the gas lift necessary during the artificial raising of oil in the pre-salt region, the use of a saline solution is contra-indicated by international organizations such as NORSOK and NACE. State-of-the-art alternatives use other types of fluids or additives to attempt to get around this problem, such as for example:
Synthetic drilling fluids;
Suspensions of micronized solids in an organic base;
Continual dosage of corrosion inhibitor; and
Basic glycerin/monoethylene glycol fluid.

Given the conditions encountered in the pre-salt region, bearing in mind the need for a fluid of a density equal to or higher than 1.15 g/cm³ (9.8 lb/gal), and due to the limited mechanical resistance of the lining, the synthetic fluid and suspension of micronized solids presents a number of limitations, such as for example: the need for a large amount of solids in suspension (to offer the density desired), or the use of heavier brines than those of sodium chloride. The presence of solids in suspension, even micronized, may damage the valves of the gas lift while heavier brines would increase the rate of corrosion.

Chemical product companies offer a series of additives for saline packer fluids with the function basically of a biocide and corrosion inhibitor. Technical literature on packer fluids basically describes the selection of additives for packer fluids, as in U.S. Pat. No. 7,219,735.

In Brazilian Patent PI 0405109-2, inverse emulsion fluids are described, which can be useful in drilling operations, packer and the stimulation of hydrocarbon wells, and which comprise an oleophilic phase comprised of 60% to 99% volume of an in natura vegetable oil added from a lower proportion of an ester, a disperse aqueous phase, additives and soy lecithin as an emulsifier. Inverse emulsion fluids are stable at high temperatures and they are completely free of aromatic derivatives, which is particularly appropriate from an environmental point of view. The application of inverse emulsion fluids includes injecting these into hydrocarbon wells during drilling, packer and the stimulation of hydrocarbon wells.

Brazilian Patent PI 0504298-4 describes compositions containing tensoactive compounds which may have a variation range of surface equilibrium and/or dynamic tensions and a variation range of foaming performance attributes.

In Brazilian Patent PI 0505054-5, a method of producing a compound, formulation, drilling fluid, packer, cementing, stimulation, fracturing, acidulation or the completion of works in a subterranean petroleum or gas well is described, or to deal with or increase the production level of petroleum or gas from a producer formation of petroleum or gas, a method of drilling, packer, cementing, stimulation, fracturing, acidulation, the completion of works or handling of a subterranean well, and a method for handling a flux produced from oil or gas originating from a petroleum and gas transporting formation. N,N-dialkyl-poly-hydroxy-alkylamines may be produced from the reductive alkylation of an N-alkyl-poly-hydroxy-alkylamine with an aldehyde or ketone, or with an equivalent compound in the presence of a transition metal catalyst and hydrogen. The reaction is performed in a reaction solvent which contains at least 30% and the weight of one organic solvent. Use of a sufficiently high proportion of an appropriate organic solvent in the reaction mixture reduces the amount of water present in the reaction mixture and provides fast reaction rates and high yields of the desired product.

N,N-dialkyl-poly-hydroxy-alkylamines can be used in a wide range of applications.

The current state of techniques in relation to the composition of packer fluids is vast; however, formulations based on biodiesel glycerin designed for application in deep and ultra-deep wells in environments with high concentrations of CO₂ are not known. With the increase in reserves originating in the pre-salt region, the search is on to increase the efficiency of well packer processes in these new deposits with a view to making these reserves economically viable.

### SUMMARY OF INVENTION

This invention describes a composition of a packer fluid which comprises biodiesel glycerin to be used in deep and ultra-deep wells in environments containing CO₂, and a well packer process using this packer fluid.

Herein, biodiesel glycerin is considered to comprise the glycerin obtained as a subproduct of the transesterification of oils or fats of animal or vegetable origin in the production of biodiesel.

Packer fluid based on biodiesel glycerin, which is the subject of this invention, comprises in its composition:
Water content varying between 0% and 20% w/w; and
Glycerol content varying between 75% and 80% w/w.

In addition, the composition of the referred fluid may present:
Chloride content of no more than 4% w/w;
Ash content of no more than 6% w/w; and
Matter Organic Non-Glycerol (MONG) of no more than 4% w/w.

Optionally, composition of the referred fluid may include additives such as:
Bactericide in a concentration of up to 1% w/w;
Emulsion preventer in a concentration of up to 1% w/w; and
Oxygen scavenger agent in a concentration of up to 1% w/w.

In accordance with the specific needs of the reservoirs found in the pre-salt region, the fluid in question preferably has a specific mass of at least 1.15 g/cm³ to maintain hydrostatic pressure, appropriate viscosity to pump at less than 2,000 cP and corrosive potential of up to 3 mm in 30 years. In addition to this, the composition of this packer fluid should be compatible with the elastomers employed, be capable of withstanding environments containing CO₂ and be capable of not degrading when exposed to temperatures lower than 100° C.

This invention has a field of application in deep and ultra-deep wells with the presence of CO₂ but may also be applied in other types of wells which need the characteristics described.

In this regard, a further embodiment of the invention is a well packer process for deep and ultra-deep oil wells, comprising the injection of a packer fluid comprising a biodiesel glycerin into an oil well.

### BRIEF DESCRIPTION OF THE DRAWING

The composition of packer fluid for deep and ultra-deep wells in environments containing CO₂, which is the subject of this invention, is better understood from the detailed description which is set out below merely as an example, associated with the design referred to below which comprises an integral part of this report.

The drawing illustrates the solubility graph of CO₂ in NaCl (9.8 lb/gal NaCl @ 60.1° C. and 250 Kgf/cm²).

### DETAILED DESCRIPTION OF INVENTION

It is to be understood that both the foregoing general description and the following detailed description are exemplary and are intended to provide further explanation of the invention claimed.

Well packer occurs in a series of steps. Initially, equipment is installed which enables safe access to the well interior and then the conditioning of the production lining is carried out, leaving the production lining set up to receive the necessary equipment. During this stage the well is cleaned, fluid from the interior of the well is replaced with a packer fluid and light solids and/or drilling residues are removed.

This invention describes a composition of a packer fluid which comprises biodiesel glycerin to be used in deep and ultra-deep wells in environments containing CO₂.

As mentioned above, biodiesel glycerin is taken to be glycerin obtained as a subproduct of the transesterification of oils or fats of animal or vegetable origin in the production of biodiesel.

Packer fluid based on biodiesel glycerin, which is the subject of this invention, comprises in its composition:
Water content varying between 0% and 20% w/w; and
Glycerol content varying between 75% and 80% w/w.

In addition, the composition of the referred fluid may present:
Chloride content of no more than 4% w/w;
Ash content of no more than 6% w/w; and
Matter Organic Non-Glycerol (MONG) of no more than 4% w/w.

Optionally, composition of the referred fluid may include additives such as:
Bactericide in a concentration of up to 1% w/w;
Emulsion preventer in a concentration of up to 1% w/w; and
Oxygen scavenger agent in a concentration of up to 1% w/w.

Packer fluid characterized in this way has weak acidity and this less than 0.1 mg of KOH/g of fluid.

The calorific power of this packer fluid ranges from 3200 kcal/kg to 3500 kcal/kg (13.40 MJ/kg-14.65 MJ/kg).

In accordance with the specific needs of the reservoirs found in the pre-salt region, the packer fluid used should have a specific mass of at least 1.15 g/cm³ to maintain hydrostatic pressure without causing damage to the producer setup and to reduce the pressure gradient between the production column and the lining to avoid collapse.

In addition to this, the specific mass should not fall below this limit even at high temperatures.

The packer fluid proposed in this invention meets the requirements set forth above as can be seen in Table 1 below.

The specific mass values for the packer fluid based on biodiesel glycerin were determined in a digital densimeter using the ASTM D4052 method at temperatures of 20° C., 40° C. and 60° C.

Based on these values, the equation of the curve and specific mass was calculated for temperatures of 80° C. and 100° C.

TABLE 1
Results of specific mass of packer fluid as a
result of temperature

| Temperature (° C.) | Specific mass (g/cm³) |
|---|---|
| 20.0 | 1.2657 |
| 40.0 | 1.2536 |
| 60.0 | 1.2412 |
| 80.0 | 1.2300 |
| 100.00 | 1.2180 |

Another physical characteristic which the packer fluid should offer in these operating conditions is related to appropriate viscosity for pumping. For the conditions in deep and ultra-deep wells, a packer fluid should have a viscosity of less than 2,000 cP at temperatures of 20° C. The packer fluid of this invention behaves as a Newtonian fluid with viscosity values at 60° C. and 4° C. of 29.0 and 1195.0 mPa at 20 s⁻¹, respectively.

In deep and ultra-deep wells in production, it is common to use artificial lifting methods for the production of formation fluids. One of the methods most commonly used is lifting using a gas lift. This method employs the injection of a gas containing CO₂ via the ring between the lining and production column to valves which enable the passage of this gas into the production column at the bottom of the well. This gas mixed with the formation fluid reduces its density and enables the pressure of the reservoir to be enough to promote the lifting of this fluid.

Because of this, the packer fluid should be compatible with the CO₂ employed in this method, behaving in a way so as to present a low solubility of this gas in this fluid. The packer fluid of this invention meets this requirement by having a CO₂ solubility in a static condition of no more than 2.0%.

A packer fluid should also have properties that do not favor the natural process of the corrosion of production linings, columns and equipment. The packer fluid proposed in this invention has a corrosive potential of less than 0.10 mm/year.

In addition to this, it is also worth emphasizing the compatibility of the packer fluid of this invention with the elastomers used in safety and sealant equipment present in petroleum production wells. According to the NORSOK M-710 standard, the volumetric variation of the samples of elastomers commonly used (HNBR and AFLAS type) is less than 10%, which is considered excellent.

In short, packer fluid to meet the premises of production in the pre-salt region consists of a fluid capable of maintaining the hydrostatic pressure of the well without causing damage to the producer formation and reducing the pressure gradient between the production column and the lining to avoid collapse and protecting metals and elastomers from corrosion. Its primary field of application is in the packer of deep and ultra-deep wells with the presence of CO₂ but may also be applied in other types of wells which need these same characteristics described in detail.

### EXAMPLES

The characteristics of the packer fluid described in this invention are demonstrated in the following experimental trials designed for the chemical and physical characterization of this fluid, assessing its behavior when exposed to the gas lift containing CO₂, evaluation of its corrosive potential and compatibility with elastomers.

The behavior of three compositions of the fluid based on glycerin was assessed, absolute standard (AS) glycerin, biodiesel glycerin (in accordance with the invention) and a mixture of 75% AS glycerin and 25% monoethylene glycol (MEG), as alternatives to the saline solutions normally used as packer fluid as these are not suitable for the scenario of the pre-salt production.

### Chemical and Physical Characterization of Fluids

The results of the physical characterization of the samples mentioned above are presented in Table 2.

As may be observed regarding the specific mass of the AS glycerin and biodiesel sample, these have the same order of magnitude, in line with the specified premise of a specific mass of more than 1.15 g/cm³. In addition to this, the much lower fluidity point of biodiesel glycerin favors its application as this does not compromise drainage at low temperatures.

TABLE 2
Results of physical characterization of samples

| | | AS Glycerin/Ethylene | Glycerin |
|---|---|---|---|
| | | Glycol | from |
| TEST | AS Glycerin | (75/25) | Biodiesel |
| Water (w/w %) | 0.50 | 0.55 | 11.5 |
| Specific mass at | 1.2604 | 1.2109 | 1.2653 |
| 20° C. (g/cm³) | | | |
| Fluidity Point (° C.) | 17.0 | Unspecified | −39.0 |

The chemical characterization of the fluid based on biodiesel glycerin is presented in Table 3.

TABLE 3
Results of chemical characterization of fluid based on
biodiesel glycerin

| TEST | VALUES |
|---|---|
| Water Content | 11.5 w/w % |
| Acidity | Weak Acidity, <0.1 mg KOH/g |
| Chloride | CI = 3.74% (w/w %) |
| Ash Content | 5.8% (w/w %) |
| Glycerol Content | 78.9% (w/w %) |
| MONG | 3.8% (w/w %) |
| Higher Calorific Power | 3575 kcal/kg (14.97 MJ/kg) |

Variation of Specific Mass with Temperature

The specific mass values of the fluids: AS glycerin and biodiesel glycerin were specified in a digital densimeter using the ASTM D4052 method, at temperatures of 20° C., 40° C. and 60° C. Based on these values, the equation of the curve was determined and specific mass was calculated for the temperatures of 80° C. and 100° C., as shown in Table 4.

TABLE 4
Results of specific mass as a result of temperature

SPECIFIC MASS (g/cm³)

| TEMPERATURE (° C.) | AS Glycerin | Biodiesel Glycerin |
|---|---|---|
| 20.0 | 1.2604 | 1.2657 |
| 40.0 | 1.2480 | 1.2536 |
| 60.0 | 1.2353 | 1.2412 |
| 80.0 | 1.2250 | 1.2300 |
| 100.0 | 1.2130 | 1.2180 |

As can be observed, the specific mass values of the fluid based on biodiesel glycerin are of the same order of magnitude as standard glycerin throughout the entire temperature range.

### Rheology Assessment of Samples

The rheology assessment of the fluids was carried out in a rotating rheometer with a shearing rate interval of 20 to 250 s⁻¹ and temperature of between 60° C. and 4° C. As can be observed in Table 5, the fluids behave like Newtonian fluid at the shearing range used. In this case, the viscosity values of biodiesel are equivalent to the values of the standard glycerin/ethylene glycol mixture.

Based on the results of the physical characterization, one observes that the biodiesel glycerin of this example presents a specific mass equivalent to that of standard glycerin and viscosity of the standard glycerin/ethylene glycol mixture (75/25), in line with the preliminary and essential requirements for its application as a packer fluid for deep and ultra-deep wells.

TABLE 5
Viscosity of glycerin samples

| | Viscosity (mPa · s) at 20 s⁻¹ | | |
|---|---|---|---|
| TEMP. | AS | Glycerin/Ethylene Glycol | Biodiesel |
| (° C.) | Glycerin | (75/25) | Glycerin |
| 60.0 | 80.4 | 28.5 | 29.0 |
| 50.0 | 143.8 | 45.8 | 44.4 |
| 40.0 | 278.2 | 75.7 | 75.8 |
| 30.0 | 586.3 | 140.2 | 142.0 |
| 20.0 | 1382.0 | 279.6 | 292.8 |
| 15.0 | 2231.0 | 407.3 | 439.0 |
| 12.0 | 3044.0 | 520.5 | 571.0 |
| 8.0 | 4571.0 | 726.2 | 818.1 |
| 4.0 | 6879.0 | 1025.0 | 1195.0 |

Based on the results of the physical characterization, one notes that the biodiesel glycerin of this example presents a specific mass equivalent to that of standard glycerin and viscosity of the standard glycerin/ethylene glycol mixture (75/25), in line with the preliminary and essential requirements for its application as a packer fluid for deep and ultra-deep wells.

### Behavior of Packer Fluid Exposed to Gas Lift Containing CO₂

### Solubility of CO₂ in Static Condition

Research carried out on the solubility of carbonic gas was limited to subcritical conditions and the aqueous phase.

Research was not extended to the organic environment but limited to information collated in specific literatures with the understanding that the solubility of CO₂ in critical conditions suffers a significant increase.

For analysis of solubility in saline solutions data published on the IUPAC website was used.

As with any gaseous mixture in contact with liquids, the components of the gas used for the gas lift are solubilized by the packer fluid in accordance with the proportion of components in the gas and also their respective solubilities in an aqueous phase. Usually, the proportions between the gaseous components are specified in terms of partial pressures which correspond to the pressure which the component would exercise if it alone occupied the gaseous volume. Hence, for the CO₂ present in the annular, specification of its solubility may be simplified with use of the tables provided by several institutions. For saline solutions, a slight reduction in the solubility of the CO₂ in relation to pure water occurs. In accordance with the IUPAC tables, we have:

TABLE 6
CO₂ SOLUBILITY
SOLUBILITY OF CO₂ IN NaCI (*)

| Temp. (° C.) | % CO₂ (mol) in gas | % m CO₂ in solution | % m NaCI |
|---|---|---|---|
| 60.1 | 0.00 | 0.00 | 23.4 |
| | 2.55 | 0.22 | |
| | 4.65 | 0.40 | |
| | 5.42 | 0.47 | |
| | 10.25 | 0.85 | |
| | 11.71 | 0.96 | |
| | 14.36 | 1.13 | |
| | 19.32 | 1.45 | |
| | 29.79 | 1.97 | |
| | 39.33 | 2.32 | |

(*) Source: IUPAC-NIST Solubility Database - NIST Standard Reference Database 106 (http://srdata.nist.gov/solubility/sol_detail.asp?sys_ID=62_172)

It must be considered that 23.4% of NaCl corresponds to the weight of 9.8 lb/gal but that solubility suffers only a slight reduction with the increase in salinity. Hence, for practical purposes, we can graphically extrapolate the variation in solubility with salinity based on the table values.

A percentage of CO₂ in the gas of 5% for the conditions observed in the Tupi field corresponds to the partial pressure of 12.5 kgf/cm².

### Effect of Salinity on Solubility of CO₂

TABLE 7
EFFECT OF SALINITY ON SOLUBILITY OF CO₂

| T | | d (lb/gal) of | % m CO₂ in | % m |
|---|---|---|---|---|
| (° C.) | P (Kgf/cm²) | solution | solution | NaCI |
| 50 | 0.882 | 8.4 | 0.068 | 2.9 |
| | 0.882 | 8.5 | 0.065 | 5.9 |
| | 0.882 | 8.8 | 0.059 | 11.7 |
| | 0.882 | 9.1 | 0.047 | 17.6 |
| | 0.882 | 9.4 | 0.040 | 23.4 |
| | 0.882 | 9.6 | 0.037 | 29.3 |
| | 0.882 | 9.8 | 0.033 | 35.9 |
| 75 | 0.623 | 8.2 | 0.034 | 0.6 |
| | 0.623 | 8.4 | 0.033 | 5.9 |
| | 0.623 | 8.7 | 0.031 | 11.7 |
| | 0.623 | 9.2 | 0.028 | 23.4 |
| | 0.623 | 9.7 | 0.026 | 35.1 |

(*) Source: IUPAC-NIST Solubility Database - NIST Standard Reference Database 106 (http://srdata.nist.gov/solubility/sol_detail.asp?sys_ID=62_171)

Based on the values presented in this table it was calculated that in the production conditions of the Tupi well, for example, the percentage concentration in mass of CO₂ in the packer fluid is 0.44% as can be seen in the drawing.

### Corrosion

To run tests, the test samples (TSs) were mechanically polished up to emery # 400, washed with distilled water, degreased using acetone and dried using hot air via a thermal blower. Subsequently, the stainless steels were passivated in a solution of nitric acid (HNO₃ @ 25%) for 15 minutes; after passivation, they were washed, degreased and dried once more.

Subsequently, the TSs were measured using a digital pachymeter with a precision of 0.01 mm and weighed on an analytical scale with a precision of 0.1 mg. Supports made out of Teflon were used to distribute the TSs inside the autoclave, a Hastelloy C-276 and coated internally with Teflon, with a capacity of 2 liters. Three TSs of the same material were distributed on the support as follows: One TS at the bottom of the autoclave, another immersed in the solution and near the liquid-vapor interphase and another in the vapor phase.

Before transfer of the test solution, this was de-aired with N₂ in a glass vessel for 3 days. The autoclave and its lines were de-aired for the same period of time. Once the system's de-airing phase was completed, the test solution was transferred at a pressure difference of 15 psi N₂.

The system was designed in such a way that during transfer of the solution there was no contact with the TSs of the vapor phase. The autoclave was closed, maintaining this slight pressurization to avoid O₂ entering the system. Then the system was pressurized up to 30 bar CO₂ and heated to 60° C. Testing pressure was verified daily and whenever necessary the system was re-pressurized to keep the CO₂ pressure constant.

On completion of the test, the TSs were removed from the solution and the generalized rate of corrosion was estimated according to the procedures of the ASTM G1 standard. The presence of pitting was verified on visual inspection of the surface of the TSs under magnifying glass and optical microscope, with a magnification of 100×, pursuant to the ASTM G46 standard. Mixtures of 75% glycerin and monoethylene glycol (MEG) 25% per volume were tested with and without the presence of water (in a proportion of 10%) and glycerin from dehydrated and hydrated biodiesel was also tested.

The results of the uniform and localized corrosion rates of the glycerin and MEG, hydrated or not, are presented in Table 8 below and following this in Table 9, the results obtained with glycerin from hydrated and dehydrated biodiesel are presented. The approval criterion is as follows: material with a uniform and localized corrosion rate of less than 0.10 mm/year is approved, otherwise it is rejected.

As can be observed both in the composition of the fluid based on dehydrated AS glycerin, the glycerins of dehydrated and hydrated biodiesel contaminated with CO₂ were considered approved with regards to the corrosion criterion for P-110 carbon steel and 13Cr-5Ni-2Mo stainless steel.

TABLE 8
Uniform & Localized Corrosion Rates of glycerin and MEG

| | Weak | | | | Uniform | | Localized | |
|---|---|---|---|---|---|---|---|---|
| | Acidity | | % H₂O | | Corrosion | | Corrosion | |
| | MG KOH/g | | (initial) | | (mm/year) | | (mm/year) | |
| Solution | Initial | Final | final | Steel | Liquid | Vapor | Liquid | Vapor |
| Glycerol | — | 0.15 | (—) | P-110 | 0.01 ± 0.01 | 0.00 | 0.04 ± 0.01 | 0.03 |
| @ 100% | | | 5.73 | 13Cr—5Ni—2Mo | 0.00 | 0.00 | 0.00 | 0.05 |
| 30 bar CO2 - | | | | | | | | |
| 60° C. - 20 days | | | | | | | | |
| Glycerol | — | <0.10 | (—) | P-110 | 0.04 ± 0.01 | 0.00 | 0.20 | 0.14 |
| @ 90% | | | 12.89 | 13Cr—5Ni—2Mo | 0.00 | 0.00 | 0.00 | 0.00 |
| 30 bar CO2 - | | | | | | | | |
| 60° C. - 20 days | | | | | | | | |
| Ethylene | <0.05 | <0.34 | (0.20) | P-110 | 0.085 ± 0.025 | 0.00 | 0.035 ± 0.035 | 0.31 |
| Glycol | | | 3.59 | 13Cr—5Ni—2Mo | 0.00 | 0.00 | 0.00 | 0.00 |
| @ 100% | | | | | | | | |
| 30 bar CO2 - | | | | | | | | |
| 60° C. - 20 days | | | | | | | | |
| Ethylene | <0.05 | <0.10 | (8.06) | P-110 | 0.09 ± 0.01 | 0.02 | 0.02 | 0.02 |
| Glycol | | | 7.95 | 13Cr—5Ni—2Mo | 0.00 | 0.00 | 0.00 | 0.10 |
| @ 90% | | | | | | | | |
| 30 bar CO2 - | | | | | | | | |
| 60° C. - 20 days | | | | | | | | |
| (MEG- | | | | P-110 | 0.024 ± 0.006 | 0.02 | 0.00 | 0.20 |
| 25%/Glycerol | | | | | | | | |
| 75%) | <0.10 | 0.28 | (—) | 13Cr—5Ni—2Mo | 0.00 | 0.00 | 0.00 | 0.12 |
| @ 100%; | | | 0.24 | | | | | |
| Sodium | | | | | | | | |
| Bisulfite | | | | | | | | |
| and | | | | | | | | |
| Glutaraldehyde | | | | | | | | |
| 30 bar CO2 - | | | | | | | | |
| 60° C. - 60 | | | | | | | | |
| days | | | | | | | | |
| (MEG- | | | | P-110 | 0.05 | 0.01 | 0.00 | 0.15 |
| 25%/Glycerol | | | | | | | | |
| 75%) | <0.10 | 0.27 | (8.77) | 13Cr—5Ni—2Mo | 0.00 | 0.00 | 0.00 | 0.10 |
| @ 90%; | | | 8.88 | | | | | |
| Sodium | | | | | | | | |
| Bisulfite | | | | | | | | |
| and | | | | | | | | |
| Glutaraldehyde | | | | | | | | |
| 30 bar CO2 - | | | | | | | | |
| 60° C. - 60 | | | | | | | | |
| days | | | | | | | | |

TABLE 9
Uniform & Localized Corrosion Rates of glycerin
from hydrated and dehydrated biodiesel

| | | | | | | | Rate of Corrosion | |
|---|---|---|---|---|---|---|---|---|
| | pCO₂ | T | Time | | | Type of | (mm/year) | |
| Solution | (bar) | (° C.) | (days) | Steel | Phase | Corrosion | Uniform | Localized |
| Dehydrated/ | 30 | 65 | 20 | P- | Liquid | Uniform | 0.01 ± 0.00 | — |
| De-aired | | | | 110 | Vapor | Localized | 0.00 ± 0.00 | <0.09 |
| Glycerin | | | | 13Cr—5Ni—2Mo | Liquid | Uniform | 0.00 ± 0.00 | — |
| | | | | | Vapor | Uniform | 0.00 ± 0.00 | — |
| Hydrated | 30 | 65 | 20 | P- | Liquid | Localized | 0.02 ± 0.00 | <0.09 |
| (10% H₂O)/ | | | | 110 | Vapor | Localized | 0.00 ± 0.00 | <0.09 |
| De-aired | | | | 13Cr—5Ni—2Mo | Liquid | Uniform | 0.00 ± 0.00 | — |
| Glycerin | | | | | Vapor | Uniform | 0.00 ± 0.00 | — |

Compatibility with Elastomers

The NORSOK M-710 standard (“Qualification of non-metallic sealing materials and Manufacturers”) was used to assess the compatibility of elastomers selected for packer with fluids based on glycerin/glycol and biodiesel glycerin mixtures.

In accordance with this standard, the samples of elastomers are cut, measured, weighed and placed in contact with the fluid for 28 days. After this period, the samples are reweighed, re-measured and classified in accordance with the volumetric variation. A volumetric variation lower than 10% is considered excellent and over 40% is considered a severe attack and non-recommended.

The results showed the volumetric variation of elastomer samples commonly used (HNBR and AFLAS type) and lower than 10%, therefore no problems for temperatures below 100° C. are expected.

The description of the packer fluid to comply with the premises of production in the pre-salt region, which is the subject of this invention, consists of a fluid capable of maintaining the hydrostatic pressure of the well, without causing damage to the producer formation; reducing the pressure gradient between the production column and the lining to avoid collapse; and protecting metals and elastomers from corrosion.

Further, another embodiment of the invention, as would be understood from the foregoing description, is a well packer process for deep and ultra-deep oil wells, which comprises the injection of a packer fluid comprising a biodiesel glycerin into an oil well. The well packer fluid employed in the well packer process may consist essentially of a biodiesel glycerin described herein, that is, a composition including biodiesel glycerin along with only those materials that do not materially affect the basic and novel characteristic(s) imparted by the biodiesel glycerin described herein above. In some instances, the well packer fluid employed in the well packer process may consist of the biodiesel glycerin described herein, that is, a composition including only the biodiesel glycerin. The well packer process includes obtaining the biodiesel glycerin by any means, such as, for example, producing biodiesel glycerin as a subproduct of the transesterification of oils or fats of animal or vegetable origin in the production of biodiesel, producing biodiesel glycerin by other means, or by commercially obtaining biodiesel glycerin.

The description made here of the composition of the packer fluid for deep and ultra-deep wells in environments containing CO₂ which is the subject of this invention, must be considered solely as a possible implementation and any particular characteristics introduced into this must be solely understood as something which was described to help facilitate comprehension.

The present invention is susceptible to various modifications and alternative means, and specific examples thereof have been shown by way of example as described in detail. It should be understood, however, that the present invention is not to be limited to the particular devices or methods disclosed, but to the contrary, the present invention is to cover all modifications, equivalents, and alternatives falling within the spirit and scope of the claims.

What is claimed is:

1. A composition of packer fluid for deep and ultra-deep wells in environments containing CO₂ comprising biodiesel glycerin.

2. The composition of packer fluid in accordance with claim 1, further comprising:
a water content between 0% and 20% w/w; and
a glycerol content varying between 75% and 80% w/w.

3. The composition of packer fluid in accordance with claim 1, further comprising:
a chloride content of no more than 4% w/w;
an ash content of no more than 6% w/w; and
a Matter Organic Non-Glycerol (MONG) content of no more than 4% w/w.

4. The composition of packer fluid in accordance with claim 1, further comprising one or more of a bactericide, an emulsion preventer and an oxygen scavenger.

5. The composition of packer fluid in accordance with claim 4, wherein when the bactericide is present in a concentration of up to 1% w/w.

6. The composition of packer fluid in accordance with claim 4, wherein the bactericide is present in a concentration of up to 1% w/w.

7. The composition of packer fluid in accordance with claim 4, wherein the emulsion prevention is present in a concentration of up to 1% w/w.

8. The composition of packer fluid in accordance with claim 4, wherein the oxygen scavenger agent is present in a concentration of up to 1% w/w.

9. The composition of packer fluid in accordance with claim 1, wherein the composition has a weak acidity of less than 0.1 mg of KOH/g of fluid.

10. The composition of packer fluid in accordance with claim 1, wherein the composition has a calorific power in the range of 3200 kcal/kg-3500 kcal/kg.

11. The composition of packer fluid in accordance with claim 1, wherein the composition has a specific mass of at least 1.15 g/cm³.

12. The composition of packer fluid in accordance with claim 1, wherein the composition does not degrade when exposed to temperatures lower than 100° C.

13. The composition of packer fluid in accordance with claim 1, wherein the composition has a viscosity less than 2,000 cP at a temperature of 20° C.

14. The composition of packer fluid in accordance with claim 1, wherein the composition has a CO₂ solubility in a static condition of no more than 2.0%.

15. The composition of packer fluid in accordance with claim 1, wherein the composition has a corrosive potential lower than 0.10 mm/year.

16. The composition of packer fluid in accordance with claim 1, wherein the composition is compatible with elastomers of the HNBR and AFLAS types.

17. A well packer process for deep and ultra-deep oil wells, comprising:
obtaining a packer fluid comprising a biodiesel glycerin; and
injecting the packer fluid into an oil well.

18. The process in accordance with claim 17, wherein the packer fluid comprises a water content of 0-20 w/w % and a glycerol content of 75-80 w/w %.

19. The process in accordance with claim 17, wherein the packer fluid has a weak acidity of less than 0.1 mg of KOH/g of fluid.

20. The process in accordance with claim 17, wherein the packer fluid has a specific mass of at least 1.15 g/cm³.

21. The process in accordance with claim 17, wherein the packer fluid has viscosity less than 2,000 cP at 20° C.
